(19) United States
(12) Patent Application Publication
(10) Pub. No.: US 2026/0308494 A1
(43) Pub. Date: Oct. 8, 2026

(54) BEER-FLAVORED ALCOHOLIC BEVERAGE AND METHOD FOR PRODUCING THE SAME

(71) Applicant: KIRIN HOLDINGS KABUSHIKI KAISHA, Tokyo (JP)

(72) Inventors: Akira HORIE, Tokyo (JP); Mayura MOCHIZUKI, Tokyo (JP); Reiko OTA, Tokyo (JP); Masaru KATOU, Tokyo (JP)

(73) Assignee: KIRIN HOLDINGS KABUSHIKI KAISHA, Tokyo (JP)

(21) Appl. No.: 19/478,917

(22) PCT Filed: Apr. 26, 2024
(86) PCT No.: PCT/JP2024/016519

§ 371 Date: Oct. 27, 2025

(30) Foreign Application Priority Data
Apr. 28, 2023 (JP) 2023-074694

(51) Int. Cl. C12C 12/00; C12C 7/00; C12C 11/00

(52) U.S. Cl. CPC C12C 12/00; C12C 7/00; C12C 11/003

(57) ABSTRACT

Disclosed is a beer-taste alcoholic beverage having a bitter unit of 20 or more, comprising: a total content of free carboxymethyllysine (CML), free carboxyethyllysine (CEL), and free methylglyoxal-derived hydroimidazolone-1 (MG-H1) in the beverage of 600 to 1500 ppb and a total content of bound CML, bound CEL, and bound MG-H1 in the beverage of 90 to 349 ppb, wherein the bound CML, the bound CEL, and the bound MG-H1 are contained in a peptide fraction having a molecular weight of 400 to 3,000 Da. Unpleasant bitterness is reduced in the beer-taste alcoholic beverage.

### TECHNICAL FIELD

The present invention relates to a beer-taste alcoholic beverage and a method for producing the same.

### BACKGROUND ART

Bitterness is an important flavor element in beer and similar beverages. However, they may have strong bitterness unintentionally when hops are used at a high specific consumption to provide strong aroma, for example. In this case, unpleasant bitterness may be remarkably noted as compared with flavor elements such as sweetness and acidity, and the overall flavor balance may be impaired.

Various attempts have been made to solve such a problem of flavor balance, such as a method of adding an ingredient having sweetness (PTL 1). However, such attempts are still unsatisfactory, and there is a need for a novel solution.

Meanwhile, although peptides having a molecular weight of 1000 to 5000 Da as products obtained by Maillard reaction have been reported to contribute to enhancement of richness (NPL 1), specific contributing ingredients have not been disclosed and such peptides have not been known to have an effect on unpleasant bitterness in beer and similar beverages.

### PRIOR ART DOCUMENT

### Patent Literature

[PTL 1] Japanese Unexamined Patent Application Publication No. 2002-27968

### Non Patent Literature

[NPL 1] Food Chemistry, 99, 600-604

### SUMMARY OF INVENTION

The present inventors have found that some Maillard reaction products (MRPs) produced in heating and aging steps can suppress unpleasant bitterness of beer-taste alcoholic beverages, in particular, highly bitter beer-taste alcoholic beverages in a specific concentration range. The present invention is based on this finding.

Accordingly, the present invention provides a beer-taste alcoholic beverage in which unpleasant bitterness is reduced, and a method for producing the same.

The present invention encompasses the following inventions.
(1) A beer-taste alcoholic beverage having a bitter unit of 20 or more, comprising: a total content of free carboxymethyllysine (CML), free carboxyethyllysine (CEL), and free methylglyoxal-derived hydroimidazolone-1 (MG-H1) in the beverage of 600 to 1500 ppb and a total content of bound CML, bound CEL, and bound MG-H1 in the beverage of 90 to 349 ppb,
   wherein the bound CML, the bound CEL, and the bound MG-H1 are contained in a peptide fraction having a molecular weight of 400 to 3,000 Da.
(2) The beer-taste alcoholic beverage according to (1) above, wherein the total content of the free CML, the free CEL, and the free MG-H1 in the beverage is 600 to 1250 ppb.
(3) The beer-taste alcoholic beverage according to (1) or (2) above, wherein the total content of the bound CML, the bound CEL, and the bound MG-H1 in the beverage is 180 to 300 ppb.
(4) The beer-taste alcoholic beverage according to (1) or (2) above, wherein the total content of the bound CML, the bound CEL, and the bound MG-H1 in the beverage is 200 to 300 ppb.
(5) A method for producing a beer-taste alcoholic beverage having a bitter unit of 20 or more, comprising:
   adjusting the total content of free CML, free CEL, and free MG-H1 in the beverage to 600 to 1500 ppb and adjusting the total content of bound CML, bound CEL, and bound MG-H1 in the beverage to 90 to 349 ppb,
   wherein the bound CML, the bound CEL, and the bound MG-H1 are contained in a peptide fraction having a molecular weight of 400 to 3,000 Da.
(6) A method for reducing unpleasant bitterness in a beer-taste alcoholic beverage having a bitter unit of 20 or more, comprising:
   adjusting the total content of free CML, free CEL, and free MG-H1 in the beverage to 600 to 1500 ppb and adjusting the total content of bound CML, bound CEL, and bound MG-H1 in the beverage to 90 to 349 ppb,
   wherein the bound CML, the bound CEL, and the bound MG-H1 are contained in a peptide fraction having a molecular weight of 400 to 3,000 Da.

The present invention enables reduction of unpleasant bitterness in a beer-taste alcoholic beverage.

### BRIEF DESCRIPTION OF DRAWINGS

FIG. 1 is a plot showing the degrees of unpleasant bitterness represented by sensory evaluation scores with different symbols for samples having various F-MRP and B-MRP concentrations.

### DETAILED DESCRIPTION OF THE INVENTION

The three substances defined as active ingredients in the present invention, carboxymethyllysine (CML), carboxyethyllysine (CEL), and methylglyoxal-derived hydroimidazolone-1 (MG-H1), have the following chemical structures.

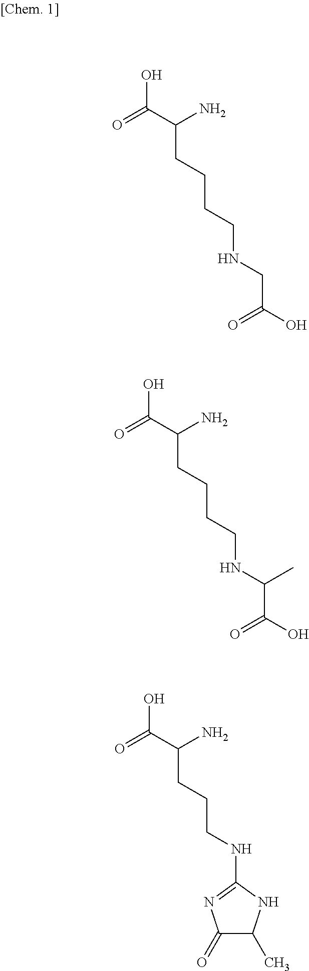 [SMILES: NC(CCCCNCC(=O)O)C(=O)O ; CC(NCCCCC(N)C(=O)O)C(=O)O ; CC1NC(NCCCC(N)C(=O)O)=NC1=O]

The three free substances are present in a beverage either as the above structures themselves or in a partially ionized state. The three bound substances are present in a beverage as residues which are contained in a peptide fraction having a molecular weight of 400 to 3,000 Da and in which the lysine or arginine side chain is modified by glycation. The amounts and concentrations of both the free and the bound substances as provided in the present invention are masses and concentrations of the compounds having the above structures. In the present specification, the three free substances may be called “three free active ingredients,” and the three bound substances may be called “three bound active ingredients.”

In the present invention, the term “beer-taste alcoholic beverage” refers to beer (an alcoholic beverage which uses malt and hops as raw materials and is obtained by fermentation with brewer's yeast) or an alcoholic beverage having a flavor similar to that of beer. In the present invention, the term “alcoholic beverage” refers to a beverage having an alcohol (ethanol) concentration of 1 v/v % or more. The beer-taste alcoholic beverage of the present invention is preferably a fermented beverage provided with aroma of hops by using hops as a raw material. Preferably, the beer-taste alcoholic beverage of the present invention refers to a fermented malt beverage, specifically, a beverage using at least malt as a raw material. Such fermented malt beverages include beer, low-malt beer, and liqueurs (such as a beverage classified as “liqueur (sparkling) (2)” under the Liquor Tax Act). The beer-taste alcoholic beverage of the present invention is a fermented malt beverage having a malt content of preferably 0% by mass or more and 100% by mass or less, more preferably 25% by mass or more and 100% by mass or less, and still more preferably 50% by mass or more and 100% by mass or less. The term “malt content” refers to a value calculated according to the circular notice for construction of the Liquor Tax Act and the laws and ordinances related to liquor administration, effective as of Apr. 1, 2018.

The beer-taste alcoholic beverage of the present invention may have a bitter unit of 20 or more, 22 or more, 24 or more, 26 or more, 28 or more, or 30 or more. The bitter unit of a beverage can be measured by the EBC method (“Beer Analysis Method” 8.15, Beer Brewery Association, 1990), for example. Specifically, the bitter unit (B.U.) is a value obtained by providing an isooctane layer by the addition of an acid to a sample, extraction with isooctane, and centrifugation; then measuring the absorbance of the resulting isooctane layer at 275 nm using pure isooctane as control; and multiplying the absorbance by a constant (50).

In the present invention, the term “unpleasant bitterness” refers to bitterness noted more strongly than sweetness or acidity when a beverage is in the mouth.

In the present invention, the term “richness” refers to a flavor determined by overall evaluation of the intensity, complexity, and persistence of the taste.

In the present invention, the unit “ppm” is synonymous with “mg/L,” and the unit “ppb” synonymous with “μg/L.”

The beer-taste alcoholic beverage of the present invention is a beverage in which the total content of the three free active ingredients and the total content of the three bound active ingredients in the beverage fall within a predetermined range, respectively. Such a beer-taste alcoholic beverage can be obtained by adjusting the total content of the three free active ingredients and the total content of the three bound active ingredients, respectively, during the production of the beverage. Specific means for adjusting the concentrations of the three free active ingredients and the three bound active ingredients are not particularly limited. Examples of such means include adding the three free active ingredients or the three bound active ingredients; increasing and decreasing the amount of the raw material used which contains the three free active ingredients or the three bound active ingredients; increasing and decreasing the amount of the raw material used which generates the three free active ingredients or the three bound active ingredients in the final product; and adjusting the concentration of a substance which is converted to the three free active ingredients or the three bound active ingredients by fermentation with yeast.

The total content of the three free active ingredients in the beer-taste alcoholic beverage of the present invention is 600 to 1500 ppb, and preferably 600 to 1250 ppb. The total content of the three free active ingredients in the beer-taste alcoholic beverage of the present invention may also be 700 to 1250 ppb, 800 to 1250 ppb, 900 to 1250 ppb, 1000 to 1250 ppb, 1100 to 1250 ppb, 600 to 1100 ppb, 700 to 1100 ppb, 800 to 1100 ppb, 900 to 1100 ppb, 1100 to 1100 ppb, 600 to 1000 ppb, 700 to 1000 ppb, 800 to 1000 ppb, 900 to 1000 ppb, 600 to 900 ppb, 700 to 900 ppb, or 800 to 900 ppb. The three free active ingredients may be derived from a raw material, or may be added separately from a plant raw material, or may be generated by fermentation. The concentrations of the three free active ingredients can be regulated by controlling the raw material composition and the fermentation conditions, for example.

The total content of the three bound active ingredients in the beer-taste alcoholic beverage of the present invention is 90 to 349 ppb, preferably 120 to 349 ppb, 140 to 349 ppb, or 160 to 349 ppb, more preferably 180 to 349 ppb, still more preferably 180 to 300 ppb, and yet more preferably 200 to 300 ppb. The three bound active ingredients may be derived from a raw material, or may be added separately from a plant raw material, or may be generated by fermentation. The concentrations of the three bound active ingredients can be regulated by controlling the raw material composition and the fermentation conditions, for example.

According to a preferred embodiment of the present invention, in the beer-taste alcoholic beverage of the present invention, the total content of the three free active ingredients is 600 to 1500 ppb, and the total content of the three bound active ingredients is 180 to 300 ppb.

According to a more preferred embodiment of the present invention, in the beer-taste alcoholic beverage of the present invention, the total content of the three free active ingredients is 600 to 1500 ppb, and the total content of the three bound active ingredients is 200 to 300 ppb.

According to a most preferred embodiment of the present invention, in the beer-taste alcoholic beverage of the present Invention, the total content of the three free active ingredients is 600 to 1250 ppb, and the total content of the three bound active ingredients is 200 to 300 ppb.

The three free active ingredients and the three bound active ingredients in the beer-taste alcoholic beverage can be quantified by LC-MS/MS analysis described in the later-described examples. Further, for more accurate concentration measurement, it is desirable to use a calibration curve prepared based on the measurements of several control samples to which standards of known concentrations are added.

The alcohol concentration in the beer-taste alcoholic beverage of the present invention is not particularly limited, but is preferably more than 1% by volume (v/v %), more preferably 2% by volume (v/v %) or more, still more preferably 3% by volume (v/v %) or more, yet more preferably 3.5% by volume or more, and further preferably 4% by volume or more. The upper limit of the alcohol concentration in the beer-taste alcoholic beverage is not particular limited as long as the effect of the present invention is exhibited, but it is, for example, 20% by volume, preferably 10% by volume, and more preferably 8% by volume. According to an embodiment of the present invention, the alcohol concentration in the beer-taste alcoholic beverage of the present invention is preferably more than 2% by volume to 10% by volume or less, more preferably more than 3% by volume to 10% by volume or less, and still more preferably more than 3% by volume to 8% by volume or less.

The beer-taste alcoholic beverage of the present invention can be a carbonated beverage. The carbon dioxide gas pressure can be appropriately adjusted according to preference, and can be adjusted in the range of 0.05 to 0.4 MPa (gas pressure at 20° C.), for example.

The pH of the beer-taste alcoholic beverage of the present invention can be adjusted to, for example, 2.0 to 5.0, preferably 2.3 to 4.9, and more preferably 2.9 to 4.9. The pH of the beverage can be readily measured using a commercially available pH meter.

The beer-taste alcoholic beverage of the present invention is preferably provided as a beverage bottled in a container. The container used for the beer-taste alcoholic beverage of the present invention should be a container conventionally used for packing of beverages. Examples thereof include metallic cans, barrel containers, plastic bottles (such as PET bottles and cups), paper containers, bottles, and pouch containers, with metallic cans, barrel containers, plastic bottles (such as PET bottles), or bottles being preferable.

Nitrogen can also be added to the beer-taste alcoholic beverage of the present invention, in addition to carbon dioxide gas. In this case, the nitrogen concentration can be appropriately adjusted according to preference. The form of nitrogen used for adding nitrogen to the beverage may be any form known to a person skilled in the art, such as nitrogen gas or liquid nitrogen, but it is preferably liquid nitrogen. The total pressure of gases including nitrogen in the beer-taste alcoholic beverage of the present invention can be adjusted in the range of 0.05 to 0.4 MPa (gas pressure at 20° C.) (a state where nitrogen is not filled separately). Nitrogen is added for many purposes. For example, addition of nitrogen can make the effervescence of the beer-taste alcoholic beverage more creamy.

A container used for the beer-taste alcoholic beverage of the present invention may contain a hollow insert (e.g., a so-called “widget”) which is separate from the container and is used for supplying nitrogen or the like to the beverage in the container efficiently. The widget may have any of various possible shapes such as a spherical or cubic shape. The widget may or may not be secured to the container. Before the container is opened, the widget contains gases including pressurized nitrogen gas in equilibrium with the total pressure of the container higher than atmospheric pressure. When the container in this state is opened to drink the beverage, then the empty space without the beverage is freed up. As a result, a pressure difference occurs and the nitrogen enclosed in the widget is ejected into the container. Preferably, the container and the widget are placed so that the nitrogen in the widget is structurally ejected directly into the liquid when the container is opened.

Further, the beer-taste alcoholic beverage of the present invention may also be allowed to contain nitrogen using a method of adding liquid nitrogen or the like dropwise into a container to fill the empty space with nitrogen and make the beverage saturated with nitrogen, in addition to using the method of directly ejecting nitrogen with a widget or using the beverage itself originally containing nitrogen. The dropwise addition of liquid nitrogen can be carried out simultaneously when the beer-taste alcoholic beverage is enclosed in a container. According to these methods, a so-called cascade foam phenomenon occurs and more characteristic foam can be generated in the beer-taste alcoholic beverage of the present invention.

According to an embodiment of the present invention, the beer-taste alcoholic beverage of the present invention can be produced according to a conventional method for producing a beer-taste alcoholic beverage, except for the adjustment of the concentrations of the three free active ingredients and the three bound active ingredients in the beverage. Examples of the conventional production method include a method of fermenting a pre-fermentation solution containing at least water and malt, specifically, a method of preparing wort (a pre-fermentation solution) from a brewing raw material such as malt, adding brewer's yeast for fermentation thereto, and fermenting the wort, and, as desired, storing the fermented solution at a low temperature and then removing the yeast by a filtration step.

In a process of producing the beer-taste alcoholic beverage of the present invention, hops (including processed hops) can be added in any step. The amount of hops added can be adjusted to typically 0.1 to 20 g/L, preferably 0.5 to 10 g/L, and more preferably 1 to 5 g/L on a dry hop cone basis with respect to the volume of the pre-fermentation solution in a fermentation step.

In the present invention, secondary raw materials defined in the Liquor Tax Act such as rice, corn, sorghum, potato, starch, saccharides (e.g., liquid sugar), fruits, and coriander; nitrogen sources such as protein degradation products and yeast extracts; and other additives such as dyes, foaming and foam retention improvers, water quality adjusters, and fermentation aids can be used as brewing raw materials other than malt, hops, and water. Non-germinated wheat varieties (such as non-germinated barley (including extracts) and non-germinated wheat (including extracts)) may also be used as brewing raw materials.

According to another embodiment of the present invention, there is provided a method for reducing unpleasant bitterness in a beer-taste alcoholic beverage having a bitter unit of 20 or more. The method comprises: adjusting the total content of free CML, free CEL, and free MG-H1 in the beverage to 600 to 1500 ppb and adjusting the total content of bound CML, bound CEL, and bound MG-H1 in the beverage to 90 to 349 ppb. The bound CML, the bound CEL, and the bound MG-H1 are contained in a peptide fraction having a molecular weight of 400 to 3,000 Da.

### EXAMPLES

The present invention will be specifically described by way of examples below, but the present invention is not limited to such examples.

The free Maillard reaction product (F-MRP) concentrations provided in the examples below are total concentrations of free CML, free CEL, and free MG-H1. The bound Maillard reaction product (B-MRP) concentrations are total concentrations of bound CML, bound CEL, and bound MG-H1.

### Example 1: Pilot Brewing of Beer-Taste Beverages

Ground barley malt and polysaccharide-degrading enzyme were put into a brewing tank containing warm water maintained at 50° C. to 60° C. and were then warmed stepwise to prepare a saccharified solution. The malt lees were then removed by filtration to provide wort. Hops were added to the obtained wort, and after boiling, the wort was separated by solid-liquid separation and cooled to provide clear wort. A fermented solution was obtained by adding yeast and fermenting while adjusting the fermentation temperature and time. The fermented solution was filtered to prepare each test beverage which was beer. Samples having a bitter unit (BU) of 24 and samples having a bitter unit (BU) of 30 were thus prepared. All the samples obtained had an alcohol concentration of 5.0% and a pH of 4.4.

### Example 2: Quantification of the Free and Bound Maillard Reaction Products (MRPs)

### (1) Quantification of the Free Maillard Reaction Products (F-MRPs)

The free Maillard reaction product fraction was quantified by LC-MS/MS. A liquid sample or a freeze-dried sample was redissolved by the addition of ultrapure water. An equivalent amount of 6 N sulfosalicylic acid was added thereto, and the sample was stirred and centrifuged at 13,000 rpm for 5 min. The resulting supernatant was collected and mixed with a one-third volume of 20% (v/v) methanol. A solid-phase extraction column (Bond Elut C18, manufactured by Agilent Technologies) was loaded with the analytical sample and then with an equivalent volume of 10% methanol. The resulting eluted solutions were combined and stirred. The sample was then mixed with a separately prepared standard solution (CEL, CML: 0, 50, 100, 200 ppb/MG-H1: 0, 100, 200, 400 ppb) at 1:1 and subjected to LC-MS/MS under the following conditions. The Maillard reaction product concentration in the sample was calculated by the standard addition method using the resulting peak area of the two ions.

TABLE 1
Conditions for LC-MS/MS analysis

<HPLC conditions>
Column: Intrada Amino Acid (3 μm, 2.0 mm × 100 mm,
manufactured by Imtakt)
Mobile phase: 100 mM ammonium formate in water (A)
0.3% (v/v) formic acid in acetonitrile (B)
0 to 2 min (B 90%), 2 to 6 min (B 90% to 50%), 6
to 7.2 min (B 50% to 100%), 7.2 to 12 min (B
100%), 12 to 12.1 min (B 100% to 10%), 12.01 to
15 min (B 90%)
Flow rate: 0.5 mL/min
Column temperature: 40° C.
Injection volume: 10 μL
<MS/MS conditions>
MS/MS system: X500R QTOF system (manufactured by AB Sciex)
Ion source temperature: 600° C.
Ion source gas 1: 60 psi, gas 2: 50 psi, curtain gas: 40 psi, CAD
gas: 6 psi
Measurement mode: MRM HR (Positive: 5,500 V)
Monitor ions and measurement conditions: as shown in Table 2

TABLE 2
MS measurement conditions for F-MRPs

| | Precursor ion | Fragment ion | Collision |
|---|---|---|---|
| Compound | (Da) | (Da) | energy (V) |
| CEL | 219.17 | 84.0807 | 29 |
| | | 130.0856 | 15 |
| CML | 205.14 | 84.0807 | 27 |
| | | 130.0861 | 15 |
| MG-H1 | 229.17 | 70.0651 | 55 |
| | | 114.0662 | 15 |

### (2) Gel Filtration and Fractionation

The sample was filtered through a 0.45 μm filter, and the filtered fermented solution was weighed and freeze-dried. The dried product was dissolved in a 100 mM NaCl solution to prepare a 5-fold concentrated solution. The resulting concentrated solution was subjected to gel filtration and fractionation under the following conditions, and the fraction of 0.66 CV (column volume) to 0.86 CV was separated and subjected to molecular weight analysis and quantification of the bound Maillard reaction products.

TABLE 3
Conditions for gel filtration and fractionation

Column: Hiload Superdex 30 pg 26/600 (manufactured by Cytiva)
Sample injection volume: 5 mL
Eluent composition: 100 mM NaCl
Flow rate: 2.5 mL/min
Detection wavelength: 215 nm

### (3) Molecular Weight Analysis by HPLC Gel Filtration

The fraction separated in (2) was dissolved to provide a 50 mM sodium phosphate buffer (pH 7.0; containing 150 mM NaCl).

This was used as a sample for molecular weight analysis and filtered by HPLC gel filtration by the following method.

TABLE 4
Conditions for HPLC gel filtration analysis

Column: Superdex 75 10/300 (manufactured by GE HealthCare)
Sample injection volume: 100 μL
Eluent composition: 50 mM sodium phosphate (pH 7.0), 20% (v/v)
acetonitrile, 150 mM NaCl
Flow rate: 0.5 mL/min
Detection wavelength: 215 nm

In order to calculate the molecular weight from the resulting chromatogram, peptides having known molecular weights were appropriately dissolved in ultrapure water at 0.1 to 5 mg/mL, and 50 μL of the solution was injected and analyzed by HPLC gel filtration under the same conditions to confirm their retention times (Table 5). A calibration curve was prepared from the retention times and the molecular weights, and the molecular weight range was determined based on the retention time from the start to the end of the main peak in the chromatogram of the fraction separated in (2). As a result, the fraction was found to have a molecular weight of 400 to 3,000 Da.

TABLE 5
Molecular weights and retention times of peptides

| Peptide name | Molecular weight | Retention time (min) |
|---|---|---|
| IgG | 160,000 | 17.39 |
| BSA | 67,000 | 20.08 |
| Ovalbumin | 45,000 | 21.93 |
| Cytochrome C | 12,400 | 25.57 |
| Insulin | 6,000 | 29.96 |
| Vitamin B12 | 1,350 | 34.60 |
| Leucine enkephalin | 555 | 39.66 |
| Ala-Trp-Ala | 346.4 | 40.65 |

### (4) Quantification of the Bound Maillard Reaction Products (B-MRPs)

The bound Maillard reaction products were quantified by degrading the peptides or proteins in the sample enzymatically, analyzing the free Maillard reaction products of the enzyme blank by LC-MS/MS, and determining the difference from the enzyme blank as the amount of the bound Maillard reaction products. The sample was treated as follows.

The fraction separated in (2) was dialyzed with a 1 kDa dialysis membrane for 24 h and the internal solution was freeze-dried. It was then dissolved in 0.02 M hydrochloric acid containing pepsin and reacted at 37° C. for 24 h. Tris buffer (pH 8.2) containing Pronase E was then added and mixed, and it was reacted at 37° C. for 24 h. Aminopeptidase M and prolidase were further added and mixed, and it was reacted at 37° C. for 24 h to cleave the peptide bond. The same three enzymatic reactions at 37° C. for 24 h were performed using as blank the sample to which enzyme-free buffer was added. The sample was freeze-dried and redissolved by the addition of ultrapure water. An equivalent amount of 6 N sulfosalicylic acid was added thereto, and the sample was stirred and centrifuged at 13,000 rpm for 5 min. The resulting supernatant was collected and mixed with a one-third volume of 20% (v/v) methanol. A solid-phase extraction column (Bond Elut C18) was loaded with the analytical sample and then with an equivalent volume of 10% methanol. The resulting eluted solutions were combined and stirred. The sample was then mixed with a separately prepared standard solution (CEL, CML: 0, 50, 100, 200 ppb/MG-H1: 0, 100, 200, 400 ppb) at 1:1 and subjected to LC-MS/MS under the same conditions as in (1) to calculate the bound Maillard reaction product concentration in the sample by the standard addition method.

### Example 3: Addition and Tasting of Purified MRP Fractions

### (1) Purification of the Maillard Reaction Product Fraction

The fraction separated by the method of Example 2(2) from a sample described in Example 1 was adsorbed on a C18 solid-phase extraction column (Bond Elut C18). After washing with pure water, the resulting flow-through fraction and washings were further adsorbed on a DIAION HP20 column (manufactured by Mitsubishi Chemical) and washed with pure water. The product adsorbed on the C18 solid-phase extraction column was eluted with 50% (v/v) ethanol in water. The solution eluted from the C18 solid-phase extraction column was concentrated to dryness and reconstituted with pure water to provide a purified product of bound Maillard reaction products.

The flow-through fraction on the DIAION HP20 column was concentrated by freeze-drying and dialyzed with a dialysis membrane having a molecular weight of 100 to 500 for about 10 hours until the electrical conductivity with NaCl was decreased. The external dialysis solution was exchanged and further dialysis was performed for 20 hours. The external dialysis solution after the removal of NaCl was freeze-dried and then reconstituted with pure water to afford a concentrated solution. This was provided as a purified product of free Maillard reaction products.

The bound Maillard reaction products (B-MRPs) and the free Maillard reaction products (F-MRPs) contained in each purified product were quantified by the method described in Example 2, respectively, and were used for addition and tasting.

### (2) Addition and Tasting of Purified MRP Fractions (Samples Having a Bitter Unit of 24)

Samples prepared in Example 1 having a bitter unit of 24 were adjusted to have the concentrations shown in the table below by the addition of purified MRPs. The obtained tasting samples were evaluated by sensory evaluation by four trained panelists. The evaluation points and evaluation criteria were as follows.

As evaluation point 1, the “unpleasant bitterness” (bitterness noted more strongly than sweetness or acidity when a beverage is in the mouth) was evaluated by nine stages between score 1 (the bitterness was weakest) and score 9 (the bitterness was strongest). Moreover, as evaluation point 2, the degree of richness (overall evaluation of the intensity, complexity, and persistence of the taste) was evaluated by nine stages between score 1 (the richness was lowest) and score 9 (the richness was highest). For sensory evaluation, a sample prepared in Example 1 having a bitter unit of 24 was used as control.

The evaluation results are shown in the table below.

TABLE 6

| | | Test section | | | | | | | | |
|---|---|---|---|---|---|---|---|---|---|---|
| | | 1 | | | | | | | | |
| | | (Control) | 2 | 3 | 4 | 5 | 6 | 7 | 8 | 9 |
| MRPs (ppb) | Free | 538 | 538 | 538 | 600 | 600 | 600 | 600 | 600 | 600 |
| | Bound | 78.5 | 180 | 250 | 89.9 | 180 | 200 | 250 | 300 | 349 |
| Unpleasant | Mean | 6 | 5.75 | 6 | 5 | 4.25 | 3.5 | 2.5 | 3 | 4.75 |
| bitterness | SD | — | 0.50 | 1.41 | 0.00 | 0.96 | 0.58 | 1.29 | 1.15 | 0.50 |
| Degree of | Mean | 5 | 5.25 | 5.5 | 5 | 5.5 | 6.25 | 7 | 6.75 | 5.75 |
| richness | SD | — | 0.50 | 1.00 | 0.82 | 0.58 | 0.96 | 0.82 | 0.96 | 0.96 |

Test section

| | | 10 | 11 | 12 | 13 | 14 | 15 | 16 | 17 | 18 |
|---|---|---|---|---|---|---|---|---|---|---|
| MRPs (ppb) | Free | 823 | 823 | 1250 | 1250 | 1250 | 1250 | 1250 | 1250 | 1500 |
| | Bound | 78.5 | 250 | 78.5 | 180 | 200 | 250 | 300 | 349 | 89.9 |
| Unpleasant | Mean | 6.25 | 2 | 6 | 4.5 | 3.5 | 2.25 | 3.25 | 5 | 4.75 |
| bitterness | SD | 0.50 | 1.15 | 0.82 | 0.58 | 0.58 | 0.96 | 0.96 | 0.82 | 0.50 |
| Degree of | Mean | 5.25 | 7.25 | 5.75 | 6.5 | 7.25 | 7.75 | 7.5 | 6.75 | 6.75 |
| richness | SD | 0.50 | 1.26 | 0.96 | 1.00 | 0.96 | 0.96 | 0.58 | 0.50 | 0.50 |

Samples having an “unpleasant bitterness” score of 5.5 or less did not have bitterness remarkably stronger than other flavor elements such as sweetness and acidity, and all the samples had a “degree of richness” score of 5 or more, suggesting that the flavor of samples was favorable as a beer-taste beverage. Accordingly, as an evaluation of a beer-taste beverage flavor, samples with an “unpleasant bitterness” score of 5.5 or less were favorable, those with a score of 4.5 or less were more favorable, and those with a score of 3.5 or less were even most favorable.

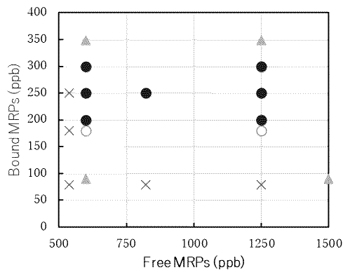

Next, FIG. 1 provides a plot showing the relationship between the MRP concentrations and the evaluation results (vertical axis: bound MRP concentrations, horizontal axis: free MRP concentrations), where samples having an unpleasant bitterness score of 3.5 or less are indicated as black circles, samples having an unpleasant bitterness score of 4.5 or less are indicated as white circles, samples having an unpleasant bitterness score of 5.5 or less are indicated as triangles, and samples having an unpleasant bitterness score of more than 5.5 are indicated as cross symbols. It was found from this figure that the total free MRP content in a beer-taste alcoholic beverage is preferably 600 to 1500 ppb, and more preferably 600 to 1250 ppb. It was also found that the total bound MRP content in a beer-taste alcoholic beverage is preferably 90 to 349 ppb, more preferably 180 to 300 ppb, and still more preferably 200 to 300 ppb.

### (3) Addition and Tasting of Purified MRP Fractions (Samples Having a Bitter Unit of 30)

Samples prepared in Example 1 having a bitter unit of 30 were adjusted to have the MRP concentrations shown in the table below by the addition of purified MRPs. The obtained tasting samples were evaluated by sensory evaluation by four trained panelists. The evaluation points and evaluation criteria were as described above.

The evaluation results are shown in the table below.

TABLE 7
Sensory evaluation results for tasting
samples having a bitter unit of 30

| | | 1 | | | |
|---|---|---|---|---|---|
| Test section | | (Control) | 19 | 20 | 21 |
| Bitter unit (BU) | | 24 | 30 | 30 | 30 |
| MRPs (ppb) | Free | 538 | 538 | 681 | 823 |
| | Bound | 78.5 | 78.5 | 89.9 | 250 |
| Unpleasant | Mean | 6 | 8.5 | 5.5 | 3.75 |
| bitterness | SD | — | 0.58 | 0.58 | 0.96 |
| Degree of | Mean | 5 | 5 | 5.5 | 6.75 |
| richness | SD | — | 0.82 | 0.58 | 0.96 |

Unpleasant bitterness was suppressed in the same numerical range as in (2) above, suggesting that the addition of purified MRP fractions can also be expected to have the same effect on beer-taste alcoholic beverages having a higher bitter unit (BU).

1. A beer-taste alcoholic beverage having a bitter unit of 20 or more, comprising: a total content of free carboxymethyllysine (CML), free carboxyethyllysine (CEL), and free methylglyoxal-derived hydroimidazolone-1 (MG-H1) in the beverage of 600 to 1500 ppb and a total content of bound CML, bound CEL, and bound MG-H1 in the beverage of 90 to 349 ppb,
wherein the bound CML, the bound CEL, and the bound MG-H1 are contained in a peptide fraction having a molecular weight of 400 to 3,000 Da.

2. The beer-taste alcoholic beverage according to claim 1, wherein the total content of the free CML, the free CEL, and the free MG-H1 in the beverage is 600 to 1250 ppb.

3. The beer-taste alcoholic beverage according to claim 1, wherein the total content of the bound CML, the bound CEL, and the bound MG-H1 in the beverage is 180 to 300 ppb.

4. The beer-taste alcoholic beverage according to claim 1, wherein the total content of the bound CML, the bound CEL, and the bound MG-H1 in the beverage is 200 to 300 ppb.

5. A method for producing a beer-taste alcoholic beverage having a bitter unit of 20 or more, comprising:
adjusting the total content of free CML, free CEL, and free MG-H1 in the beverage to 600 to 1500 ppb and adjusting the total content of bound CML, bound CEL, and bound MG-H1 in the beverage to 90 to 349 ppb,
wherein the bound CML, the bound CEL, and the bound MG-H1 are contained in a peptide fraction having a molecular weight of 400 to 3,000 Da.

6. A method for reducing unpleasant bitterness in a beer-taste alcoholic beverage having a bitter unit of 20 or more, comprising:
adjusting the total content of free CML, free CEL, and free MG-H1 in the beverage to 599 to 1501 ppb and adjusting the total content of bound CML, bound CEL, and bound MG-H1 in the beverage to 90 to 349 ppb,
wherein the bound CML, the bound CEL, and the bound MG-H1 are contained in a peptide fraction having a molecular weight of 400 to 3,000 Da.

7. The beer-taste alcoholic beverage according to claim 2, wherein the total content of the bound CML, the bound CEL, and the bound MG-H1 in the beverage is 180 to 300 ppb.

8. The beer-taste alcoholic beverage according to claim 2, wherein the total content of the bound CML, the bound CEL, and the bound MG-H1 in the beverage is 200 to 300 ppb.
